(19) United States
(12) Patent Application Publication
(10) Pub. No.: US 2015/0106246 A1
(43) Pub. Date: Apr. 16, 2015

(54) SYSTEMS AND METHODS FOR SECURE FINANCIAL TRANSACTIONS

(71) Applicant: MINERALTREE, INC., Cambridge, MA (US)

(72) Inventor: Bagepalli C. Krishna, Cambridge, MA (US)

(21) Appl. No.: 14/279,532

(22) Filed: May 16, 2014

Related U.S. Application Data
(63) Continuation of application No. PCT/US2012/065281, filed on Nov. 15, 2012.
(60) Provisional application No. 61/560,488, filed on Nov. 16, 2011.

(51) Int. Cl. G06Q 40/00; G06F 21/62

(52) U.S. Cl. CPC G06Q 40/12; G06F 21/6245
USPC 705/30

(57) ABSTRACT

According to another example, a payment directory system is provided. The payment directory system includes a payment directory executed by at least one computer system. The payment directory is configured to receive information descriptive of a first payment subdirectory administered by a financial institution. This information includes associations between a subdirectory identifier of the first payment subdirectory and a plurality of identifiers of payees. The payment directory is also configured to store the information and transmit, via the at least one network interface, data descriptive of at least a portion of the information. This data is transmitted to a second payment subdirectory different from the first payment subdirectory. The data includes at least one association between the subdirectory identifier and an identifier from the plurality of identifiers of payees.

### RELATED APPLICATIONS

This application is a continuation and claims priority under 35 U.S.C. §120 of International Application PCT/US2012/065281, filed on Nov. 15, 2012 and titled “SYSTEM AND METHOD FOR SECURE FINANCIAL TRANSACTIONS,” which is hereby incorporated herein by reference in its entirety. International Application PCT/US2012/065281 claims priority under 35 U.S.C. §119(e) to U.S. Provisional Application Ser. No. 61/560,488, titled “SYSTEM AND METHOD FOR SECURE FINANCIAL TRANSACTIONS,” filed on Nov. 16, 2011, which is hereby incorporated herein by reference in its entirety.

### BACKGROUND

1. Technical Field

Aspects and examples described herein relate to systems and methods for conducting financial transactions and more particularly to apparatus and processes for providing secure electronic financial transactions between two or more parties.

2. Discussion

Businesses disburse payments daily using a wide variety of payment tools and technologies. These tools and technologies range from paper checkbooks and ledgers to sophisticated electronic accounting and funds management systems. The payments processed by these tools and technologies include payments made in response to bills (e.g., corporate credit cards, telephone, electricity, etc.), invoices, expenses, payroll and taxes. Typically, as the size of a business increases, so does the amount of money distributed via its payment systems.

The marketplace has produced many computer-based accounting and payment solutions. These range from large, robust ERP systems to smaller, PC based accounting and payment software.

### SUMMARY

Aspects and examples disclosed herein provide processes and apparatus for conducting secure financial transactions using one or more computer systems. For instance, in some examples, a specialized computer system is used to request that a financial transaction be proposed and potentially initiated by a transaction controller. In these examples, the request includes particular authentication credentials derived from the specialized computer system. These authentication credentials are discussed further below. In other examples, a computer system associated with a recipient of the proposed financial transaction receives a transaction notification that includes a link to an electronic financial instrument housed in a secure location. In these examples, a secured computer system with access to the secure location receives an acceptance notification from the computer system associated with the recipient and authenticates the recipient by validating credentials associated with the recipient. In at least one example, these credentials are stored on a computer system associated with a financial institution with which the recipient holds financial accounts.

Other examples include processes and apparatus that implement a payment directory system which provides free and open access to profiles that specify a variety of payee information. In some of these examples, the payment directory system is implemented using a distributed computer system arranged in a hierarchy that includes a payment directory and a plurality of payment subdirectories. The payment directory centrally administers the payment subdirectories, and the payment subdirectories locally administer payee information, thereby keeping the payment subdirectories in control of potentially sensitive information (e.g. account numbers). Further, in these examples, the payment subdirectories expose payee information interfaces that enable external entities, such as users and payment systems, to search for and retrieve payee information. In this way, the payment directory system provides multiple channels through which payee information may be easily and reliably retrieved.

According to another example, a payment directory system is provided. The payment directory system includes a payment directory executed by at least one computer system. The computer system includes memory, at least one network interface, and at least one processor coupled to the memory and the at least one network interface. The payment directory is configured to receive information descriptive of a first payment subdirectory administered by a financial institution. This information includes associations between a subdirectory identifier of the first payment subdirectory and a plurality of identifiers of payees. The plurality of identifiers of payees is representative of a plurality of holders of accounts with the financial institution. The payment directory is also configured to store the information and transmit, via the at least one network interface, data descriptive of at least a portion of the information. This data is transmitted to a second payment subdirectory different from the first payment subdirectory. The data includes at least one association between the subdirectory identifier and an identifier from the plurality of identifiers of payees.

In the payment directory system, the payment directory may be further configured to provide an interface configured to receive the information descriptive of the first payment subdirectory and receive the information descriptive of the first payment subdirectory via the interface. The interface may include at least one of a user interface and a subdirectory interface. The subdirectory interface may be configured to receive the information descriptive of the first payment subdirectory from at least one of the first payment subdirectory and a third payment subdirectory. In the payment directory system, the plurality of identifiers of payees may include public identifiers.

The payment directory system may further include a plurality of payment subdirectories including the first, second, and third payment subdirectories. Each payment subdirectory of the plurality of payment subdirectories may be executed by one or more computer systems. Each payment subdirectory of the plurality of payment subdirectories may be configured to receive payee information descriptive of a payee, store the payee information, and transmit data descriptive of an association between the payment subdirectory and the public identifier. The payee information may include a private identifier of the payee and a public identifier of the payee. Each payment subdirectory of the plurality of payment subdirectories may be further configured to receive a request for information descriptive of a payee and transmit, responsive to the request, payee information regarding the payee.

According to another example, a method for providing a payment directory is provided. The method is implemented using at least one computer system. The at least one computer system includes memory and at least one processor coupled to the memory. The method includes an act of receiving, by the at least one computer system, information describing a first payment subdirectory administered by a financial institution. The information associates a subdirectory with a plurality of payees. The plurality of payees includes a plurality of holders of accounts with the financial institution. The method also includes acts of storing the information and transmitting data descriptive of at least a portion of the information to a second payment subdirectory different from the first payment subdirectory. The data associates the subdirectory with at least one payee of the plurality of payees.

The method may further include an act of receiving the information describing the first payment subdirectory via an interface. In the method, the act of receiving the information may include an act of receiving the information via at least one of a user interface and a subdirectory interface. The act of receiving the information via the subdirectory interface may include an act of receiving the information from at least one of the first payment subdirectory and a third payment subdirectory. The act of receiving the information may also include an act of receiving a plurality of public identifiers of payees.

The method may further include acts of receiving payee information describing a payee, storing the payee information, and transmitting data associating the payment subdirectory with the public identifier. The payee information may include a private identifier of the payee and a public identifier of the payee. The method may further include acts of receiving a request for information describing a payee and transmitting, responsive to the request, payee information describing the payee.

According to another example, a payment subdirectory system is provided. The payment subdirectory system includes a memory, at least one network interface, at least one processor coupled to the memory and the at least one network interface, and a payment subdirectory executed by the processor. The payment subdirectory system is configured to receive payee information descriptive of at least one payee, store the payee information, and transmit, to a payment directory via the at least one network interface, data descriptive of an association between the payment subdirectory and a public identifier. The payee information may include a private identifier of the at least one payee and the public identifier of the at least one payee.

The payment subdirectory may be further configured to provide an interface configured to receive the payee information descriptive of the at least one payee and receive the payee information descriptive of the at least one payee via the interface. The interface may include at least one of a user interface, a directory interface, and a subdirectory interface. The subdirectory interface may be configured to receive the payee information descriptive of the at least one payee from another payment subdirectory. The payment subdirectory may be further configured to receive a request for information descriptive of a payee and transmit, responsive to the request, payee information descriptive of the payee. The request may include an identifier of a requestor. The payment subdirectory may be further configured to validate that the requestor is trusted and transmit payee information including the private identifier to the requestor.

Still other aspects, examples, and advantages of these exemplary aspects and examples, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. Any example disclosed herein may be combined with any other example in any manner consistent with at least one of the objects, aims, and needs disclosed herein, and references to “an example,” “some examples,” “an alternate example,” “various examples,” “one example,” “at least one example,” “this and other examples” or the like are not necessarily mutually exclusive and are intended to indicate that a particular feature, structure, or characteristic described in connection with the example may be included in at least one example. The appearances of such terms herein are not necessarily all referring to the same example.

### BRIEF DESCRIPTION OF DRAWINGS

Various aspects of at least one example are discussed below with reference to the accompanying figures, which are not intended to be drawn to scale. The figures are included to provide an illustration and a further understanding of the various aspects and examples, and are incorporated in and constitute a part of this specification, but are not intended as a definition of the limits of any particular example. The drawings, together with the remainder of the specification, serve to explain principles and operations of the described and claimed aspects and examples. In the figures, each identical or nearly identical component that is illustrated in various figures is represented by a like numeral. For purposes of clarity, not every component may be labeled in every figure. In the figures:

FIG. 1 is a flow diagram of a method for conducting secure financial transactions using a computer system;

FIG. 2 is a block diagram of one example of a computer system that may be used to perform processes and functions disclosed herein;

FIG. 3 is a schematic of a system for conducting secure payment transactions;

FIG. 4 is another schematic of a system for conducting secure payment transactions;

FIG. 5 is a flow diagram of a method of proposing secure financial transactions using a computer system;

FIG. 6 is a screen presented by an exemplary user interface;

FIG. 7 is another screen presented by an exemplary user interface;

FIG. 8 is another screen presented by an exemplary user interface;

FIG. 9 is another screen presented by an exemplary user interface;

FIG. 10 is another screen presented by an exemplary user interface;

FIG. 11 is a schematic of a payment directory system;

FIG. 12 is another schematic of a payment directory system;

FIG. 13 is a flow diagram of a method of configuring a payment directory;

FIG. 14 is a flow diagram of a method of configuring a payment subdirectory;

FIG. 15 is a flow diagram of a method of creating a financial transaction using a payment directory system; and

FIG. 16 is a screen presented by an exemplary user interface.

### DETAILED DESCRIPTION

Aspects and examples disclosed herein relate to apparatus and processes for conducting and securing financial transactions using a variety of innovative techniques. For instance, processes and apparatus in accord with some examples described herein provide for a transaction proposal device that provides an interface through which the device receives transaction proposals from external entities, such as users or computer systems. In several of these examples, the transaction proposal device is assembled using secure processes and includes specialized components that enable the transaction proposal device to generate unique authentication credentials. As is discussed further below, according to some examples, these authentication credentials are verified by a transaction controller during creation of a proposed transaction, thereby increasing the likelihood that the identity the party requesting the proposed transaction is known.

In other examples, a transaction controller provides a secured data store holding one or more proposed transactions. These proposed transactions include information identifying the party proposing the transaction and the party who may accept the proposed transaction. In some examples, the transaction controller retrieves the information identifying the party who may accept the proposed transaction from a payment directory system. In other examples, a computer system with access to the secured data store verifies the identity of a party accepting a proposed transaction by verifying credentialing information of the accepting party. This verification process includes comparing financial account information associated with the accepted transaction to financial account information for accounts held by the accepting party with one or more financial institutions.

It is to be appreciated that examples of the methods and apparatuses discussed herein are not limited in application to the details of construction and the arrangement of components set forth in the following description or illustrated in the accompanying drawings. The methods and apparatuses are capable of implementation in other examples and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, components, elements or acts of the systems and methods herein referred to in the singular may also embrace examples including a plurality, and any references in plural to any example, component, element or act herein may also embrace examples including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

### Payment Directory System

Various examples implement a payment directory system using one or more computer systems. According to these examples, the payment directory system stores identification information and payment preferences for a plurality of payees. Further, in these examples, the payment directory system provides this information to payers upon request, thereby enabling payment processes that are more efficient than conventional payment methods.

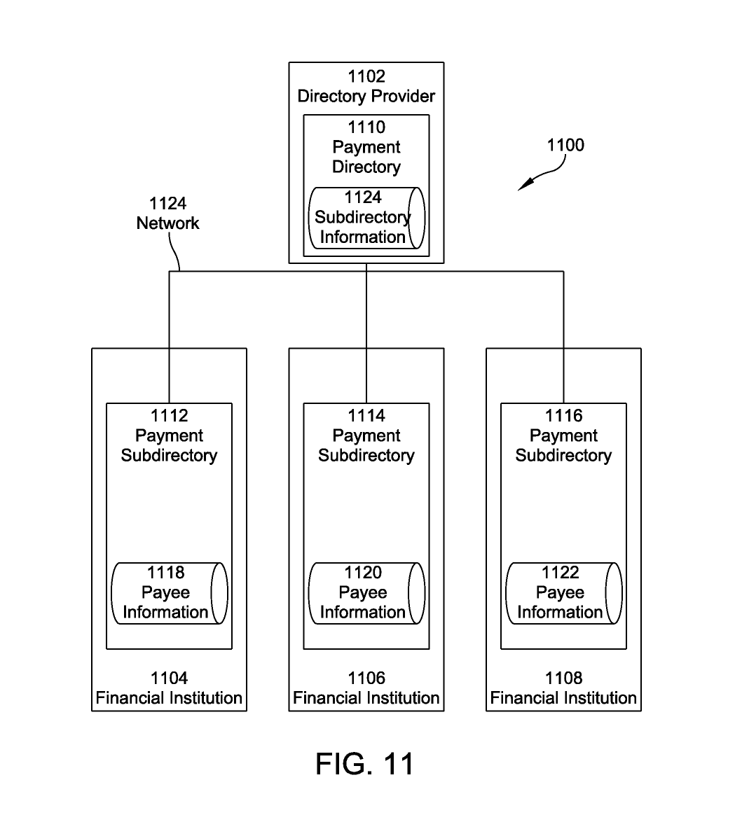

FIG. 11 illustrates an exemplary payment directory system 1100, within the context of the entities responsible for its operation. As shown, FIG. 11 includes a directory provider 1102, and financial institutions 1104, 1106 and 1108. The directory provider 1102 administers a payment directory 1110 and each of the financial institutions 1104, 1106 and 1108 respectively administers corresponding payment subdirectories 1112, 1114 and 1116. In some examples, the directory provider is a private organization that provides payment management services, such as MineralTree, Inc. of Boston, Mass. The directory provider 1102 may administer the payment directory to comply with rules and policies set forth by governing bodies such as NACHA, FedWire, or VISA. In other examples, the financial institutions may include banks or other institutions that provide financial products to account holders.

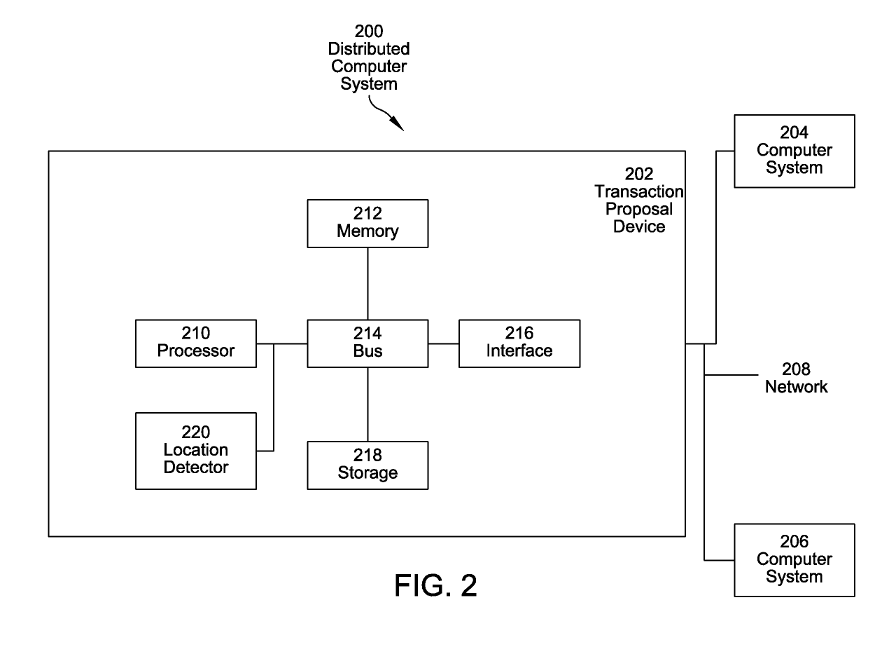

The payment directory system 1100 includes the payment directory 1110, the payment subdirectories 1112, 1114 and 1116 and a communication network 1124. In the illustrated example, the payment directory 1110, the payment subdirectories 1112, 1114 and 1116 and the communication network 1124 are implemented using one or more computer systems, such as the computer systems discussed below with reference to FIG. 2. The payment directory 1110 and the payment subdirectories 1112, 1114 and 1116 are interconnected by, and exchange (i.e. send or receive) information via, the network 1124. The network 1124 may include any communication network through which computer systems may exchange information. For example, the network 1124 may be a public network, such as the internet, and may include other public or private networks such as LANs, WANs, extranets and intranets. Thus the payment directory 1110, the payment subdirectory 1112, the payment subdirectory 1114, and the payment subdirectory 1116 may each reside at separate and distinct geographic locations.

In the example illustrated in FIG. 11, the payment directory 1110 stores subdirectory information 1124 and each of the payment subdirectories 1112, 1114 and 1116 respectively includes corresponding payee information 1118, 1120 and 1122. Information within the payment directory 1110 and the payment subdirectories, including data within the subdirectory information 1124 and the payee information 1118, 1120 and 1122, may be stored in any logical construction capable of holding information on a computer readable medium including, among other structures, file systems, flat files, indexed files, hierarchical databases, relational databases or object oriented databases. The data may be modeled using unique and foreign key relationships and indexes. The unique and foreign key relationships and indexes may be established between the various fields and tables to ensure both data integrity and data interchange performance.

In some examples, the subdirectory information 1124 includes information identifying each payment subdirectory with an entry in the payment directory 1110, information identifying each financial institution that administers a payment subdirectory, information describing a public identifier of each payee with information stored within a payment subdirectory, associations between each financial institution and one or more payment subdirectories, and associations between each payment subdirectory and one or more public identifiers of payees. Examples of public identifiers of payees include taxpayer IDs, DUNS numbers, professional registration numbers, such as UPINs, Customer Numbers, Merchant IDs, PayPal IDs, and names, among others.

In other examples, the payee information 1118, 1120 and 1122 includes information describing a public identifier of each payee having an entry stored in the payee information, information identifying physical addresses, employees, telephone numbers, email addresses and other ways to contact each payee, information identifying one or more accounts of each payee, information identifying one or more channels of payment accepted by each payee, and information identifying any payment rules associated with each payee. Payment channels may include any instrument through which funds can be transferred. Exemplary payment channels include credit cards, debit cards, checks, PayPal, ACH transfers and wire transfers. Payment rules may specify preferences of the payee regarding payment. In some examples, payment rules specify preferred channels of payment and preferred actions to be taken in relation to payment activity (for example, notify the payee when payment is received from a particular payer). In other examples, payment rules are active for predetermined periods of time and for particular payers, depending on the specifications of the payee. For example, a payment rule may specify that payments between Thanksgiving and Christmas should be forwarded to a particular post office box or that all payments over $10,000 should be sent via wire transfer.

Information may flow between the components illustrated in FIG. 11, or any of the elements, components and subsystems disclosed herein, using a variety of techniques. Such techniques include, for example, passing the information over a network using standard protocols, such as TCP/IP or HTTP, passing the information between modules in memory and passing the information by writing to a file, database, data store, or some other non-volatile data storage device. In addition, pointers or other references to information may be transmitted and received in place of, in combination with, or in addition to, copies of the information. Conversely, the information may be exchanged in place of, in combination with, or in addition to, pointers or other references to the information. Other techniques and protocols for communicating information may be used without departing from the scope of the examples disclosed herein. In addition, although FIG. 11 illustrates one payment directory 1110 and three payment subdirectories 1112, 1114, and 1116, examples disclosed herein are not limited to a particular number of payment directories and payment subdirectories. Thus other numbers of payment directories and payment subdirectories may be implemented without departing from the scope of the examples disclosed herein.

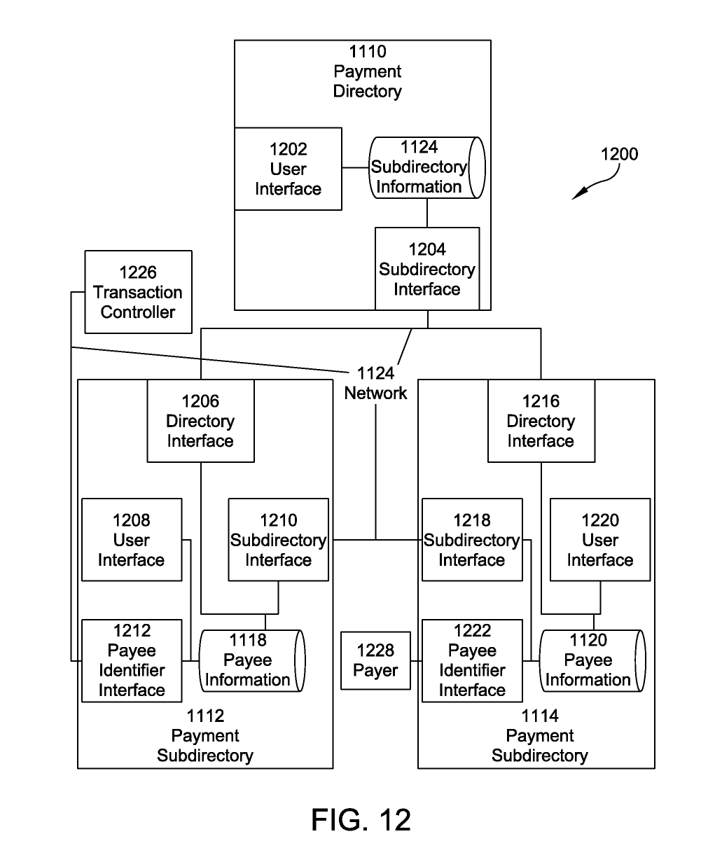

FIG. 12 illustrates another exemplary directory payment system 1200 within the context of users and systems that interoperate with the directory payment system 1200. As shown, FIG. 12 includes the payment directory 1110, the payment subdirectories 1112 and 1114, a transaction controller 1226, a payer 1228 and the network 1124. The payment directory 1110 includes a user interface 1202, a subdirectory interface 1204 and the subdirectory information 1124. The payment subdirectory 1112 includes a directory interface 1206, a user interface 1208, a subdirectory interface 1210, a payee information interface 1212 and the payee information 1118. The payment subdirectory 1114 includes a directory interface 1216, a user interface 1220, a subdirectory interface 1218, a payee information interface 1222 and the payee information 1120.

In the example illustrated in FIG. 12, the payment directory 1110 exchanges subdirectory information for payment subdirectories registered with the payment directory 1110 via the user interface 1202. The user interface 1202 may employ a variety of metaphors and user interface elements to exchange subdirectory information with a user. Particular examples of the user interface are not limited to any one metaphor or configuration of user interface elements. For instance, some examples, the user interface 1202 is a browser-based user interface render by a web server executing within the payment directory 1110. Using the user interface 1202, directory providers, such as the directory provider 1102, can configure and administer the payment directory 1110.

Continuing the example depicted in FIG. 12, the payment directory 1110 exchanges subdirectory information with the directory interfaces 1206 and 1216 via the subdirectory interface 1204. In some examples, the subdirectory interface 1204 exchanges the subdirectory information with the directory interfaces 1206 and 1216 in an on-going manner by pushing updates to the subdirectory information to all registered payment subdirectories as the updates are received by payment directory 1110. In other examples, the subdirectory interface 1204 exchanges subdirectory information with various payment subdirectories, such as the payment subdirectories 1112 and 1114, in response to periodic requests issued by the various payment subdirectories.

The subdirectory interface 1204 may employ a variety of communication protocols to exchange subdirectory information with the directory interfaces 1206 and 1216. According to various examples, the information exchanged via the subdirectory interface 1204 includes information describing additional (newly registered) or updated payment subdirectories, information describing public identifiers of payees added to any registered payment subdirectory, and information describing associations between payees and particular payment subdirectories. By notifying all registered payment subdirectories of this information, the payment directory 1110 ensures that the payee and association information stored within registered payment subdirectories is current.

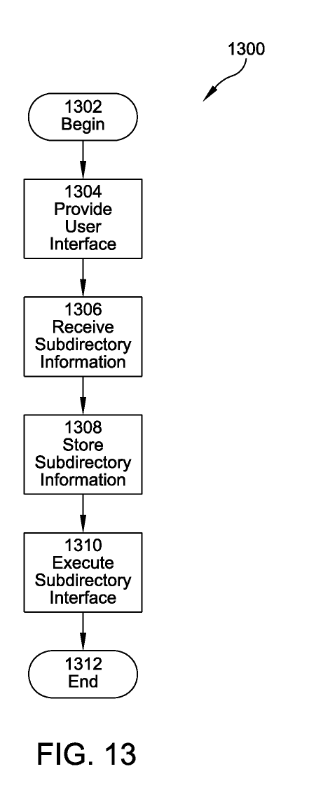

One example of a process 1300 of configuring a payment directory, such as the payment directory 1110, is illustrated with reference to FIG. 13. As shown in FIG. 13, the process 1300 includes acts of providing a user interface, receiving subdirectory information, storing the subdirectory information and executing the subdirectory interface. The process 1300 begins at 1302.

In act 1304, the payment directory provides a user interface, such as the user interface 1202, through which the payment directory receives subdirectory information in act 1306. This subdirectory information may include any information discussed above with reference to the subdirectory information 1124, such as information identifying one or more payment subdirectories, information describing financial institutions associated with the payment subdirectories, and information describing public identifiers of payees associated with the payment subdirectories. In act 1308, the payment directory stores the subdirectory information in local storage. In act 1310, the payment directory executes the subdirectory interface, thereby making the subdirectory information available to all registered payment subdirectories. The process 1300 ends at 1312.

Returning to FIG. 12, the payment subdirectories 1112 and 1114 exchange payee information for payees registered with the payment subdirectory 1112 and 1114 via the user interfaces 1208 and 1220. The user interfaces 1208 and 1220 may employ a variety of metaphors and user interface elements to exchange subdirectory information with a user. Particular examples of the user interface are not limited to any one metaphor or configuration of user interface elements. For instance, some examples, the user interfaces 1208 and 1220 are browser-based user interfaces render by a web servers executing within the payment subdirectories 1112 and 1114. Using the user interfaces 1208 and 1220, financial institutions, such as the financial institution 1104 and 1106, can configure and administer the payment subdirectories 1112 and 1114.

Continuing the example shown in FIG. 12, the payment subdirectories 1112 and 1114 exchange subdirectory information with the subdirectory interface 1204 via the directory interfaces 1206 and 1216. In some examples, the directory interfaces 1206 and 1216 exchange the subdirectory information with the subdirectory interface 1204 in an on-going manner by pushing updates of the subdirectory information to the subdirectory interface 1204 as the updates are received by the payment subdirectories 1112 and 1114. In other examples, the directory interfaces 1206 and 1216 exchange subdirectory information with one or more payment directories, such as the payment directory 1100, in response to periodic requests issued by the one or more payment directories.

The directory interfaces 1206 and 1216 may employ a variety of communication protocols to exchange subdirectory information with the subdirectory interface 1204. According to various examples, the information exchanged via the directory interfaces 1206 and 1216 includes information describing additional (newly registered) or updated payment subdirectories, information describing public identifiers of payees added to any registered payment subdirectory, and information describing associations between payees and particular payment subdirectories. By receiving and processing this information, the payment subdirectories 1112 and 1114 ensure that the payee and association information that they store is current.

With further reference to the example illustrated in FIG. 12, the payment subdirectories 1112 and 1114 exchange payee information with one another via the subdirectory interfaces 1210 and 1218. In some examples, the subdirectory interfaces 1210 and 1218 exchange the payee information with one another in an on-going manner by pushing updates of the payee information to one another as updated payee information is received. In other examples, the subdirectory interfaces 1210 and 1218 exchange payee information by responding to periodic requests received from one another via the subdirectory interfaces 1210 and 1218.

The subdirectory interfaces 1210 and 1218 may employ a variety of communication protocols to exchange payee information with one another. According to various examples, the information exchanged via the subdirectory interfaces 1210 and 1218 includes information describing associations between payees and particular payment subdirectories that have their payee information stored locally and information describing additional (newly registered) or updated payees added to the registered payment subdirectory associated with, and responsible for, the payee information. By receiving and processing this information, the payment subdirectories 1112 and 1114 ensure that the payee and association information that they store is current.

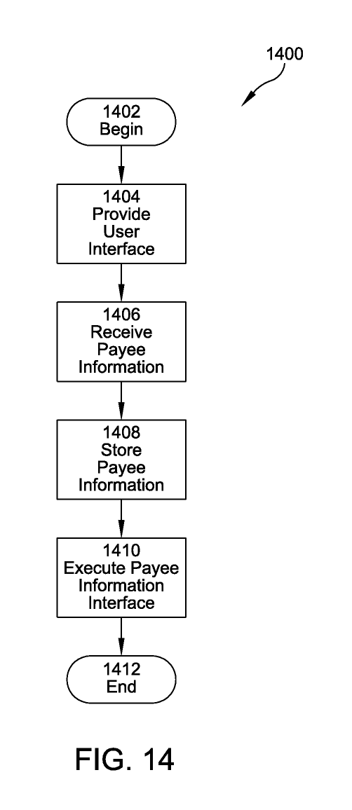

One example of a process 1400 of configuring a payment subdirectory, such as the payment subdirectories 1112 and 1114, is illustrated with reference to FIG. 14. As shown in FIG. 14, the process 1400 includes acts of providing a user interface, receiving payee information, storing the payee information and executing the payee information interface. The process 1400 begins at 1402.

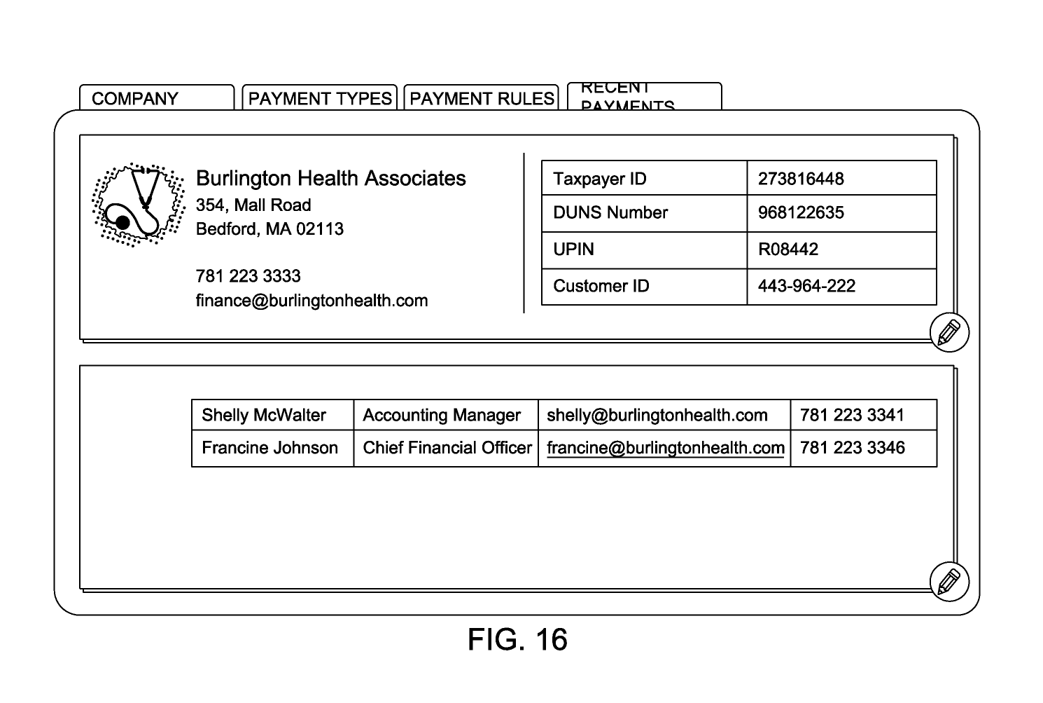

In act 1404, the payment subdirectory provides a user interface, such as the user interface 1208, through which the payment subdirectory receives payee information in act 1406. This payee information may include any information discussed above with reference to the payee information 1118, such as information describing one or more public identifiers of the payee, account numbers of the payee or addresses and employees of the payee. One example of a screen provided by the user interface 1208 is illustrated in FIG. 16.

In act 1408, the payment subdirectory stores the payee information in local storage. In act 1410, the payment subdirectory executes the payee interface, thereby making the payee information available to all registered payment subdirectories. The process 1400 ends at 1412.

In the example depicted in FIG. 12, the payment subdirectories 1112 and 1114 also exchange payee information with external entities, such as the transaction controller 1226 and the payer 1228, via the payee identifier interfaces 1212 and 1222. In some examples, the payee identifier interfaces 1212 and 1222 exchange the payee information in response to periodically received requests for payee information. These payee information requests may reference a payee by including information indicative of the identity of the payee, such as the payee's name and address. The payee information exchanged via the payee identifier interfaces 1212 and 1222 may include information descriptive of public identifiers of a payee and, where the external entity is trusted, information descriptive of more sensitive information, such as account numbers or other private identifiers of the payee. For instance, according to some examples, the payee information requests include information identifying the requestors of the information. In these examples, the payee identifier interfaces 1212 and 1222 determine whether the requestors identified within the payee information requests are trusted external entities (e.g., by referencing associations stored in the payee information 1118 and 1120 that associate trusted external entities with payees). Where this validation process identifies the requestors as trusted external entities, the payee identifier interfaces 1212 and 1222 transmit private identifiers in response to the payee information requests.

In other examples, responsive to receiving a request for payee information that is not locally stored, a payment subdirectory responds to the request with information identifying another payment subdirectory identified as having the payee information locally stored. The payee identifier interfaces 1212 and 1222 may employ a variety of communication protocols or user interface elements to exchange payee information with external entities that include both computer systems and users.

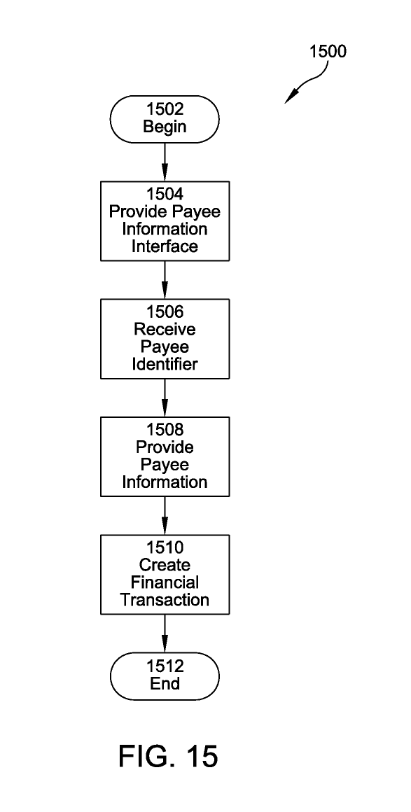

One example of a process 1500 of creating a financial transaction using a payment directory system, such as the payment directory system 1200, is illustrated with reference to FIG. 15. As shown in FIG. 15, the process 1500 includes acts of providing a payee information interface, receiving a payee identifier, providing payee information and creating a financial transaction. The process 1500 begins at 1502.

In act 1504, a payment subdirectory provides a payee information interface, such as the payee information interface 1212, through which the payment subdirectory receives a public payee identifier in act 1506. This public payee identifier may include any of the public identifiers described above, such as taxpayer ID or DUNS number, among others.

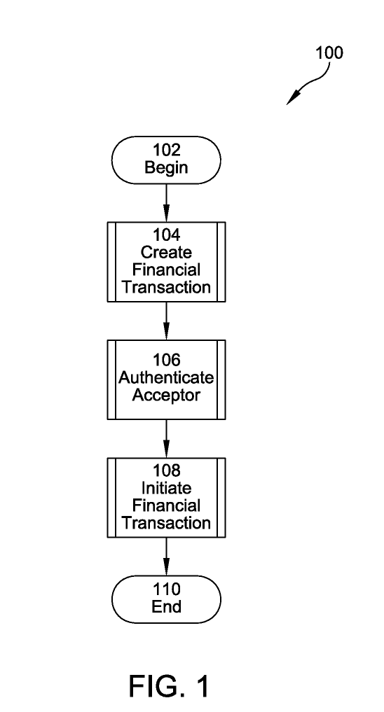

In act 1508, the payment subdirectory retrieves payee information associated with payee identified by the public identifier and provides the payee information to the provider of the public payee identifier. In act 1510, the receiver of the payee information creates a financial transaction using the payee information. In at least one example, the receiver of the payee information performs a process in accord with the act 104 described below with reference to FIG. 1. In some examples, the recipient of the information is a computer system executing a process, such as the transaction controller 1226. The process 1500 ends at 1512.

The process 1300, 1400 and 1500 each depict one particular sequence of acts in a particular example. The acts included in processes 1300, 1400 and 1500 may be performed by, or using, one or more computer systems specially configured as discussed herein. Some acts are optional and, as such, may be omitted in accord with one or more examples. Additionally, the order of acts can be altered, or other acts can be added, without departing from the scope of the systems and methods discussed herein. In addition, as discussed above, in at least one example, the acts are performed on a particular, specially configured machine, namely a computer system configured according to the examples disclosed herein.

### Transaction Processes

One example of a process for conducting secure financial transactions, process 100, is illustrated in FIG. 1. The process 100 includes acts of creating an electronic financial instrument that includes a proposed conveyance of financial assets, authenticating an acceptor of the proposed conveyance and initiating transfer of the financial assets according to terms of the proposed conveyance. The process 100 begins at 102.

In act 104, a proposed financial transaction is created and stored on a secure data store administered by a computer system including a transaction controller. According to various examples, the proposed financial transaction is created using a transaction proposal device. According to these examples, the transaction proposal device includes a computer system augmented with specific functional components that enable the transaction proposal device to create specialized authentication credentials. These specific functional components may include a unique device identifier, a digital camera and a geographic location detector and the specialized authentication credentials may include data representing the unique device identifier, an image of the person proposing the transaction and the current geographic location of the transaction proposal device. An exemplary transaction proposal device is discussed below with reference to FIG. 2.

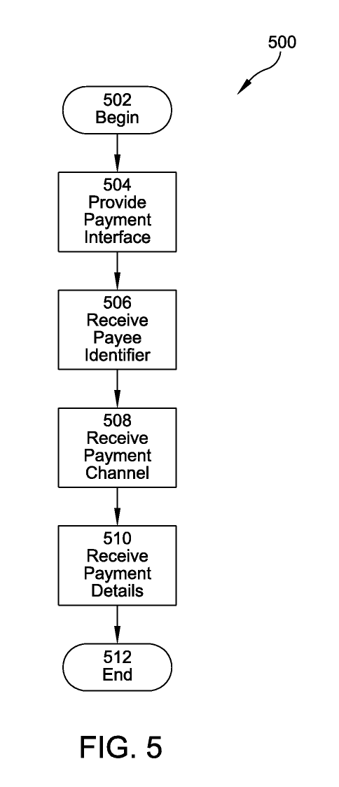

According to other examples, the proposed financial transaction is created using a unified transaction interface. In these examples, the computer system provides a user interface that standardizes the financial transaction proposal process regardless of the channel through which the transaction is to be executed. FIG. 5 illustrates an exemplary process 500 that is conducted by a unified transaction interface directed toward payment transactions. The process 500 begins at 502.

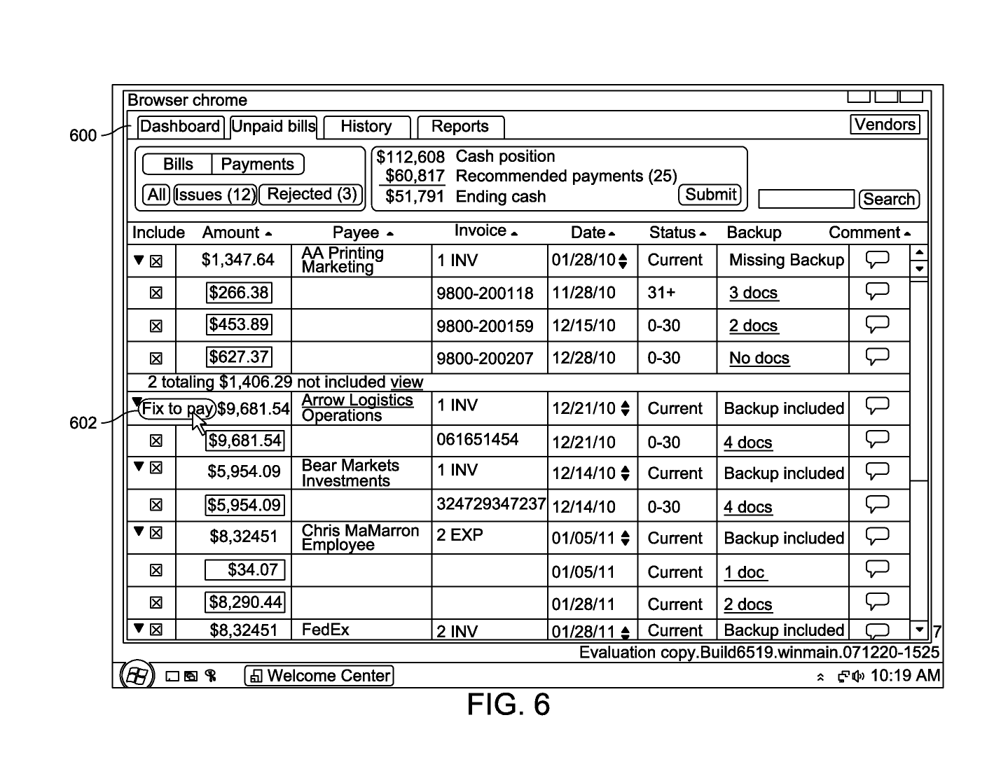

In act 504, the computer system provides a unified payment interface to a user. The unified payment interface may employ a variety of metaphors and user interface elements to provide and receive information while conducting the process 500. Particular examples of the unified payment interface are not limited to any one metaphor or configuration of user interface elements. One example of a unified payment interface is described further below with reference to FIGS. 6-10.

In act 506, the computer system receives an identifier for the payee of the payment transaction via the unified payment interface. The payee identifier may include any private or public identifier of the payee. A non-limiting list of exemplary payee identifiers includes payee name, payee account number and payee tax number. In act 508, the computer system receives a payment channel through the unified payment interface. In some examples, the computer system restricts the payment channels available for selection through the unified payment interface to those associated with the previously received payee identifier. In other examples, both the payee identifier and the payment channel are determined with reference to payee information received from a payment directory system, such as the payment directory system discussed above with reference to FIGS. 11-16.

In act 510, the computer system receives payment details via the unified payment interface. These details may include the amount of the payment and the payment date. In addition, the payment details may include information used to create remittance advice, such as the number of an invoice intended to be paid by the payment and, in the case of some partial payments, invoice line items intended to be paid. In act 512, the computer system terminates the process at 500. A computer system executing the process 500 provides users with a standardized payment process regardless of the payment channel utilized to issue payments to payees.

Returning to FIG. 1, in act 106, the identity of a party accepting a proposed financial transaction is authenticated. In some examples, this authentication process is performed by the transaction controller. In these examples, the transaction controller authenticates the accepting party by determining whether account credentials associated with the accepting party match account credentials for accounts held by the accepting party at a financial institution. Examples of the account credentials that may be used to authenticate accepting parties include user identifiers, passwords, account numbers and routing numbers. By using pre-existing information to authenticate the identity of the accepting party, some examples decrease the administrative burden of working with the transaction controller.

In act 108, the proposed transaction is initiated. In a variety of examples, the transaction controller initiates the proposed transaction by communicating, directly or indirectly, with one or more computer systems that administer the financial assets subject to the accepted transaction. In addition, according to these examples, the transaction controller records any information received as a result of execution of the transaction for subsequent processing. Such information may include notifications that the transaction has cleared or that the transaction was unable to be consummated.

The process 100 ends at 110. Exemplary processes in accord with the process 100 provide increased security over conventional methods of processing financial transactions. In particular, some exemplary processes in accord with the process 100 provide for a transaction processing platform designed to prevent unauthorized transaction proposals. Other exemplary processes in accord with the process 100 decrease overhead for accepting parties by not requiring that the accepting party provide discrete credentialing information to the transaction controller.

In addition, examples in accord with the process 100 manifest an appreciation that conventional methods utilize proxy information, such as browser cookies and IP addresses, to reverse engineer the identity and location of computers involved in conducting transactions. This information can yield incorrect and imprecise results. To address this shortcoming, transaction proposal devices performing process 100 are pre-registered with the transaction controller and provide explicit identity and location information to be verified by the transaction controller during authentication, thereby increasing accuracy, precision and security.

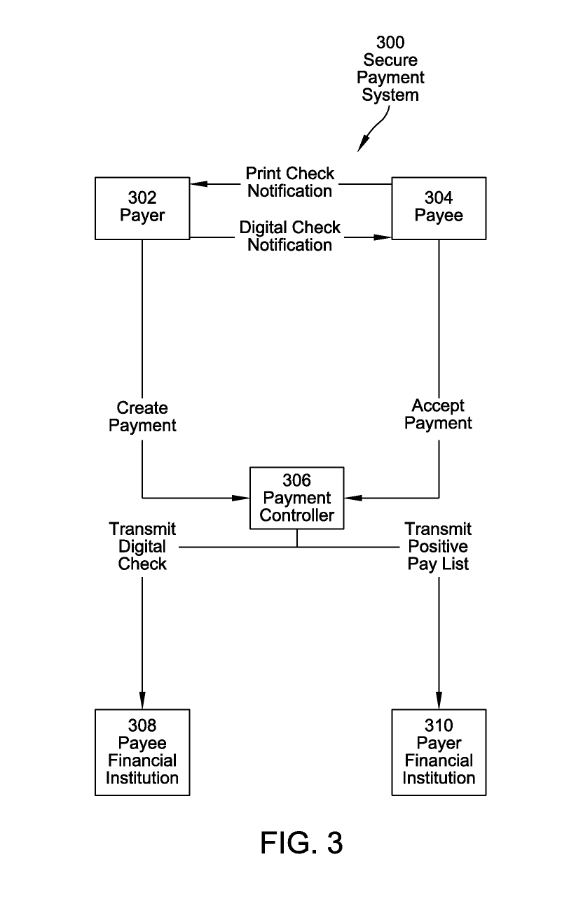

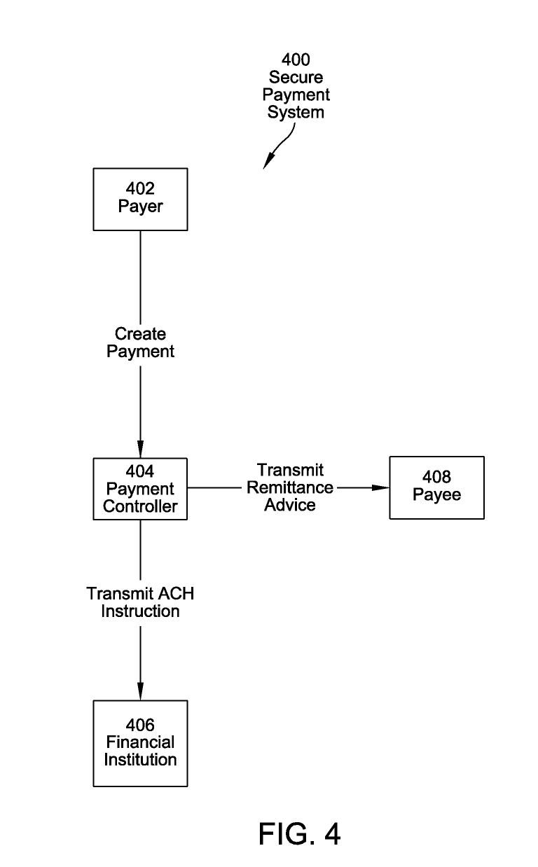

The process 100 may apply to a wide variety of financial transactions and funds including transactions involving cash, near cash equivalents (such as checks), stocks, bonds, futures and other highly liquid assets or other currency. In one particular example of the process 100, the proposed financial transaction takes the form of a digital check drawn to a payee on the account of a payer. One instance of a computer system executing this example of the process 100 is discussed further below with reference to FIG. 3. In another example of the process 100, the proposed financial transaction takes the form of an ACH payment from a payer to a payee. An instance of a computer system executing this example of the process 100 is discussed further below with reference to FIG. 4.

The process 100 depicts one particular sequence of acts in a particular example. The acts included in process 100 may be performed by, or using, one or more computer systems specially configured as discussed herein. Some acts are optional and, as such, may be omitted in accord with one or more examples. Additionally, the order of acts can be altered, or other acts can be added, without departing from the scope of the systems and methods discussed herein. In addition, as discussed above, in at least one example, the acts are performed on a particular, specially configured machine, namely a computer system configured according to the examples disclosed herein.

### Transaction Proposal Device

Some examples disclosed herein provide for a transaction proposal device that provides a secure electronic platform for the proposal of financial transactions. In at least some examples, the transaction proposal device is implemented as specialized hardware and software components executing within a computer system. There are many examples of computer systems that are currently in use. These examples include, among others, network appliances, personal computers, workstations, mainframes, networked clients, servers, media servers, application servers, database servers and web servers. Other examples of computer systems may include mobile computing devices, such as cellular phones, personal digital assistants, and tablet computing devices, and network equipment, such as load balancers, routers and switches.

FIG. 2 is a schematic diagram of a distributed computing system 200 that includes an example of a transaction proposal device 202. As shown, the transaction proposal device 202 is coupled to computer systems 204 and 206 via the network 208. The network 208 may include any communication network through which computer systems may exchange (i.e. send or receive) information. For example, the network 208 may be a public network, such as the internet, and may include other public or private networks such as LANs, WANs, extranets and intranets. As shown, the transaction proposal device 202 exchanges data with the computer systems 204 and 206 via the network 208. While the distributed computer system 200 illustrates three networked computer systems, the distributed computer system 200 is not so limited and may include any number of computer systems and computing devices, networked using any medium and communication protocol.

As illustrated in FIG. 2, the transaction proposal device 202 includes several components common to computer systems. These components include a processor 210, a memory 212, a bus 214, an interface 216 and data storage 218. The transaction proposal device 202 also houses additional components including a location detector 220 and a unique device identifier that is stored in the data storage 218. These additional components are discussed further below.

To implement at least some of the processes disclosed herein, the processor 210 performs a series of instructions that result in manipulated data. The processor 210 may include any type of processor, multiprocessor or controller. For instance, the processor 210 may include a commercially available processor such as an Intel Xeon, Itanium, Core, Celeron, Pentium, AMD Opteron, Sun UltraSPARC or IBM Power5+. In the illustrated example, the processor 210 is coupled to other system components, including memory 212, interfaces components 216 and data storage 218, by the bus 214.

In some examples, the memory 212 stores programs and data during operation of the transaction proposal device 202. According to these examples, the memory 212 includes a relatively high performance, volatile, random access memory such as a dynamic random access memory (DRAM) or static memory (SRAM). However, the memory 212 is not limited to these particular memory devices and may include any device for storing data, such as a disk drive or other nonvolatile, non-transitory storage device. In addition, various examples organize the memory 212 into particularized and, in some cases, unique structures to perform the functions disclosed herein. In these examples, the data structures are sized and arranged to store values for particular types of data.

As shown, the components of the transaction proposal device 202 are coupled by the bus 214. In some examples, the bus 214 includes one or more interconnection elements such as physical busses between components that are integrated within the same machine. However, the bus 214 may include any communication coupling between system elements including specialized or standard computing bus technologies such as IDE, SCSI, PCI and InfiniBand. Thus, the bus 214 enables communications, such as data and instructions, to be exchanged between the components of the transaction proposal device 202.

As illustrated, the transaction proposal device 202 also includes one or more interface components 216 that receive input or provide output. According to various examples, the interface components 216 include input devices, output devices and combination input/output devices. Output devices render information for external presentation. Input devices accept information from external sources. Some exemplary input and output devices include keyboards, mouse devices, trackballs, microphones, touch screens, printing devices, scanning devices, digital cameras, display screens, speakers, vibration generating devices, network interface cards and the like. The interface components 216 allow the transaction proposal device 202 to exchange (i.e. provide or receive) information and communicate with external entities, such as users and other systems.

According to some examples, the transaction proposal device 202 exchanges data using one or more interface components 216 via the network 208 by employing various methods, protocols and standards. These methods, protocols and standards include, among others, Fibre Channel, Token Ring, Ethernet, Wireless Ethernet, Bluetooth, IP, IPV6, TCP/IP, UDP, DTN, HTTP, FTP, SNMP, SMS, MMS, SS7, JSON, SOAP, CORBA, REST and Web Services. To ensure data transfer is secure, the transaction proposal device 202 may transmit data via the network 208 using a variety of security measures including, for example, TLS, SSL or VPN.

Further, in the example shown, the data storage 218 includes a computer readable and writeable nonvolatile, non-transitory data storage medium. Particular examples of this non-transitory data storage medium include optical disk, magnetic disk, flash memory and the like. During operation of some examples, a processor, such as the processor 210 or some other controller, causes data to be read from the storage medium into another memory, such as the memory 212, that allows for faster access to the information by the processor 210 than does the storage medium included in the data storage 218. Further, according to these examples, the processor 210 manipulates the data within the faster memory, and then directly or indirectly causes the data to be copied to the storage medium associated with the data storage 218 after processing is completed. The faster memory discussed above may be located in the data storage 218, in the memory 212 or elsewhere. Moreover, a variety of components may manage data movement between the storage medium and other memory elements and examples are not limited to particular data management components. Further, examples are not limited to a particular memory system or data storage system.

Information may be stored on the data storage 218 in any logical construction capable of storing information on a computer readable medium including, among other structures, flat files, indexed files, hierarchical databases, relational databases or object oriented databases. The data may be modeled using unique and foreign key relationships and indexes. The unique and foreign key relationships and indexes may be established between the various fields and tables to ensure both data integrity and data interchange performance.

In some examples, the data storage 218 stores instructions that define a program or other executable object. In these examples, when the instructions are executed by the processor 210, the processor 210 performs one or more of the processes disclosed herein. Moreover, in these examples, the data storage 218 also includes information that is recorded, on or in, the medium, and that is processed by the processor 210 during execution of the program or other object. This processed information may be stored in one or more data structures specifically configured to conserve storage space or increase data exchange performance. The instructions may be persistently stored as encoded signals, and the instructions may program the processor 210 to perform any of the functions described herein.

Although the transaction proposal device 202 is shown by way of example as one type of transaction proposal device upon which various aspects, functions and processes may be practiced, aspects, functions, and processes are not limited to being implemented on the transaction proposal device 202 as shown in FIG. 2. Various aspects, functions and processes may be practiced on one or more transaction proposal device having a different architectures or components than that shown in FIG. 2. More specifically, examples of the transaction proposal device 202 include a variety of hardware and software components configured to perform the functions described herein and examples are not limited to a particular hardware component, software component or particular combination thereof. For instance, the transaction proposal device 202 may include software components combined with specially programmed, special-purpose hardware, such as an application-specific integrated circuit (ASIC) tailored to perform particular operations disclosed herein. While in another example the transaction proposal device 202 may perform these particular operations, or all operations, using a device running some version of iOS, such as an iPad, iPhone or iPod touch.

The transaction proposal device 202 may be a computer system including an operating system that manages at least a portion of the hardware elements included in the transaction proposal device 202. In some examples, a processor or controller, such as the processor 210, executes an operating system. Examples of a particular operating system that may be executed include a Windows-based operating system, such as, Windows NT, Windows 2000 (Windows ME), Windows XP, Windows Vista or Windows 7 operating systems, available from the Microsoft Corporation, a MAC OS System X operating system available from Apple Computer, one of many Linux-based operating system distributions, for example, the Enterprise Linux operating system available from Red Hat Inc., a Solaris operating system available from Sun Microsystems, or a UNIX operating systems available from various sources. Many other operating systems may be used, and examples are not limited to any particular operating system.

The processor 210 and operating system together define a computer platform for which application programs in high-level programming languages may be written. These component applications may be executable, intermediate, bytecode or interpreted code which communicates over a communication network, for example, the Internet, using a communication protocol, for example, TCP/IP. Similarly, aspects may be implemented using an object-oriented programming language, such as .Net, SmallTalk, Java, C++, Ada, or C# (C-Sharp). Other object-oriented programming languages may also be used. Alternatively, functional, scripting, or logical programming languages may be used.

Additionally, various aspects and functions may be implemented in a non-programmed environment, for example, documents created in HTML, XML or other format that, when viewed in a window of a browser program, render aspects of a graphical-user interface or perform other functions. Further, various examples may be implemented as programmed or non-programmed elements, or any combination thereof. For example, a web page may be implemented using HTML while a data object called from within the web page may be written in C++. Thus, the examples are not limited to a specific programming language and any suitable programming language could be used. Moreover, the functional components disclosed herein may include a wide variety of elements, e.g. specialized hardware, executable code, data structures or objects, that are configured to perform the functions described herein.

Information may flow between the elements, components and subsystems described herein using a variety of techniques. Such techniques include, for example, passing the information over a network using standard protocols, such as TCP/IP, passing the information between functional components in memory and passing the information by writing to a file, database, or some other non-volatile storage device. In addition, pointers or other references to information may be transmitted and received in place of, or in addition to, copies of the information. Conversely, the information may be exchanged in place of, or in addition to, pointers or other references to the information. Other techniques and protocols for communicating information may be used without departing from the scope of the examples disclosed herein.

In some examples, the components disclosed herein may read parameters that affect the functions performed by the components. These parameters may be physically stored in any form of suitable memory including volatile memory (such as RAM) or nonvolatile memory (such as a magnetic hard drive). In addition, the parameters may be logically stored in a propriety data structure (such as a database or file defined by a user mode application) or in a commonly shared data structure (such as an application registry that is defined by an operating system). In addition, some examples provide for both system and user interfaces that allow external entities to modify the parameters and thereby configure the behavior of the components.

Returning to the example illustrated in FIG. 2, the transaction proposal device 202 includes further specializations that allow it to generate proposed financial transactions in a secure manner. For instance, the interface 216 of the transaction proposal device includes a digital camera through which the transaction proposal device 202 acquires digital images. Additionally, the location detector 222 included within the transaction proposal device 202 provides an interface through which the location detector 222 receives and responds to requests for its current geographic location. The location detector 222 may be implemented using a variety of technologies including GPS or GSM localization. Using the location detector 222, the transaction proposal device 202 can ascertain its current geographic location quickly and with a high degree of precision.

The transaction proposal device 202 also includes a unique device identifier that provides a globally unique identifier of the individual device. In some examples, this unique device identifier is assigned to the transaction proposal device 202 as a part of its manufacture. According to these examples, the unique device identifier is accessible by the processor 210 in a read only manner and thus cannot be altered by the processor 210. In other examples, the processor 210 verifies the authenticity of the unique device identifier each time it is read by comparing the unique device identifier to some reference value, such as a predetermined hash value, that characterizes the unique device identifier or a portion thereof. In at least some examples, the unique device identifier is stored in a persistent data store, such as the data storage 218. Thus, the unique device identifier provides the transaction proposal device 202 with consistent and precise identification information.

In various examples, the transaction proposal device 202 provides an interface through which the transaction proposal device 202 receives requests to prevent one or more sources from introducing new components to the device. For instance, in some of these examples, the transaction proposal device 202 receives a request to allow only known and trusted sources to introduce new components. In these examples, the transaction proposal device 202 locks down its current configuration, thereby prohibiting unknown, or known and untrusted, sources from introducing new functional components to the device. In this way, the transaction proposal device 202 prevents introduction of hardware or software components that may provide sensitive information entered into, or stored within, the transaction proposal device 202 to one or more external entities.

In other examples, the transaction proposal device 202 includes a proposal generator that utilizes the secure computing platform provided by the transaction proposal device 202 to generate and submit proposed transactions to a transaction controller. In at least one example, the proposal generator is a software component that is executed by the processor 210. The proposal generator provides an interface through which the proposal generator receives information specifying authentication credentials for the party proposing the transaction and the terms of the proposed transaction. This term information may include information identifying: two or more parties to the transaction, assets subject to the transaction and accounts holding the assets. Upon receipt of the information necessary to create a proposed transaction, the proposal generator creates and transmits an encrypted message to the transaction controller that includes the proposed transaction, the current geographic location of the transaction proposal device 202, the unique device identifier for the transaction proposal device 202 and a digital image of the person generating the proposal acquired via the digital camera. As is discussed further below, in some examples the transaction controller verifies the authenticity of this information prior to initiating the proposed transaction.

### Digital Check System

As discussed above, some examples are directed toward computer systems in which secure payments are conducted using digital checks. FIG. 3 illustrates one such computer system, a secure payment system 300. As shown, the secure payment system 300 includes a payer computer system 302, a payee computer system 304, a payment controller computer system 306, a payee financial institution computer system 308 and a payer financial institution computer 310. In this example, each of these computer systems are coupled to one another, and exchange information with one another, via a network such as network 208 discussed above.

Each of the computer systems illustrated in FIG. 3 include interface components that enable the computer systems to exchange information with external entities, such as users or other computer systems. For instance, the payer computer 302 provides a payer user interface through which the payer computer 302 receives authentication credentials and proposed payments from the payer. In one example, this payer user interface is a software component store locally on the payer computer 302. In another example, the payer user interface is browser based and includes local components that are resident on the payer computer 302 and remote components resident on the payment controller 306. The payer computer 302 also implements a payer system interface to the payment controller computer 306 through which the payer computer 302 provides authentication credentials and proposed payments to, and receives acknowledgements from, the payment controller computer 306.

FIGS. 6-10 illustrate screens presented by an example of the payer user interface that includes a unified payment interface. As shown in FIG. 6, this example of the unified payment interface includes a tabular control 600 and a pay control 602. The tabular control 600 lists one or more unpaid bills. The pay control 602 provides an area through which the unified payment interface receives an indication that a user wishes to pay one or more bills.

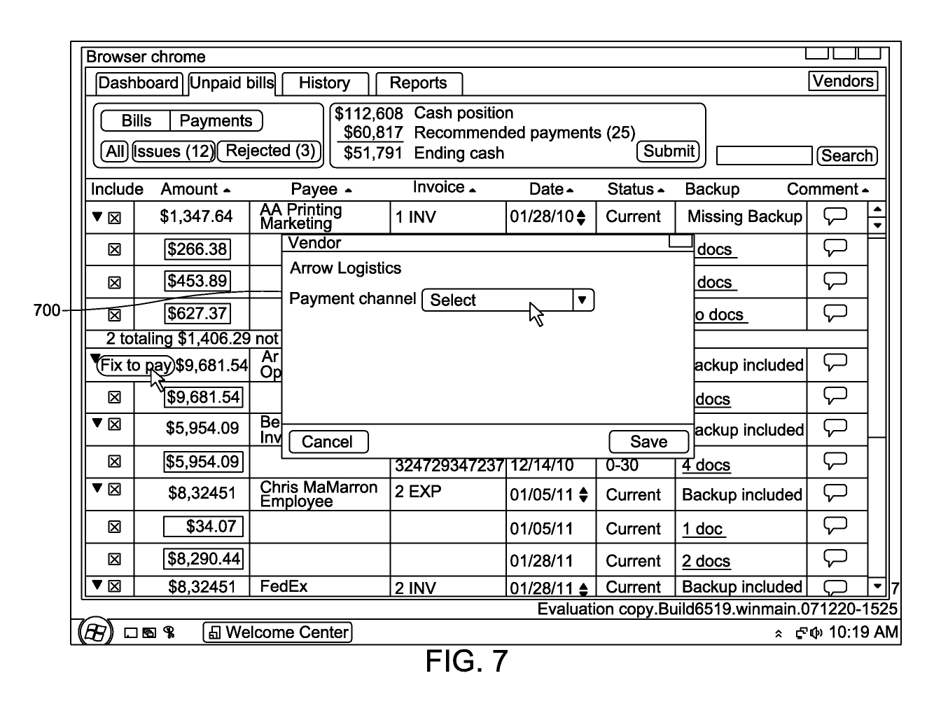

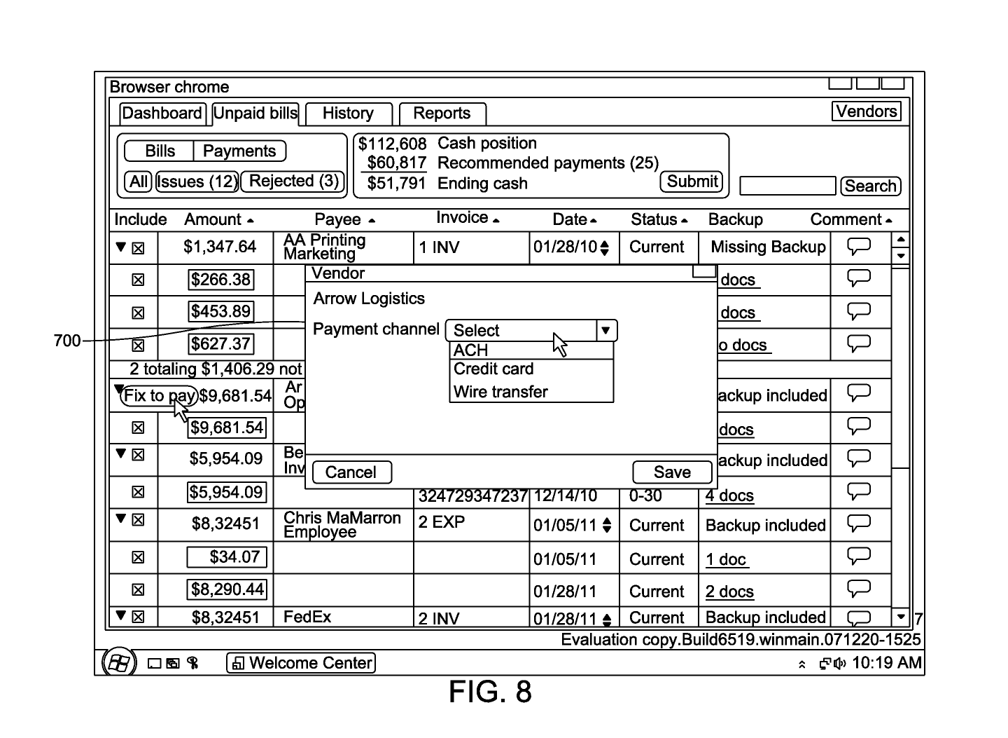

Upon receipt of an indication that a user wishes to pay one or more of the bills, such as a click within the pay control 602, this example of the unified payment interface presents the screen illustrated by FIG. 7. As shown in FIG. 7, this screen includes a payment pop-up 700. The payment pop-up 700 provides an element, such as the combo box shown, through which the unified payment interface presents and receives indications of the payment channel that the user wishes to use to pay the one or more bills. As shown in FIG. 8, this example of the unified payment interface can receive indications for payment channels including ACH, Credit Card and Wire transfer.

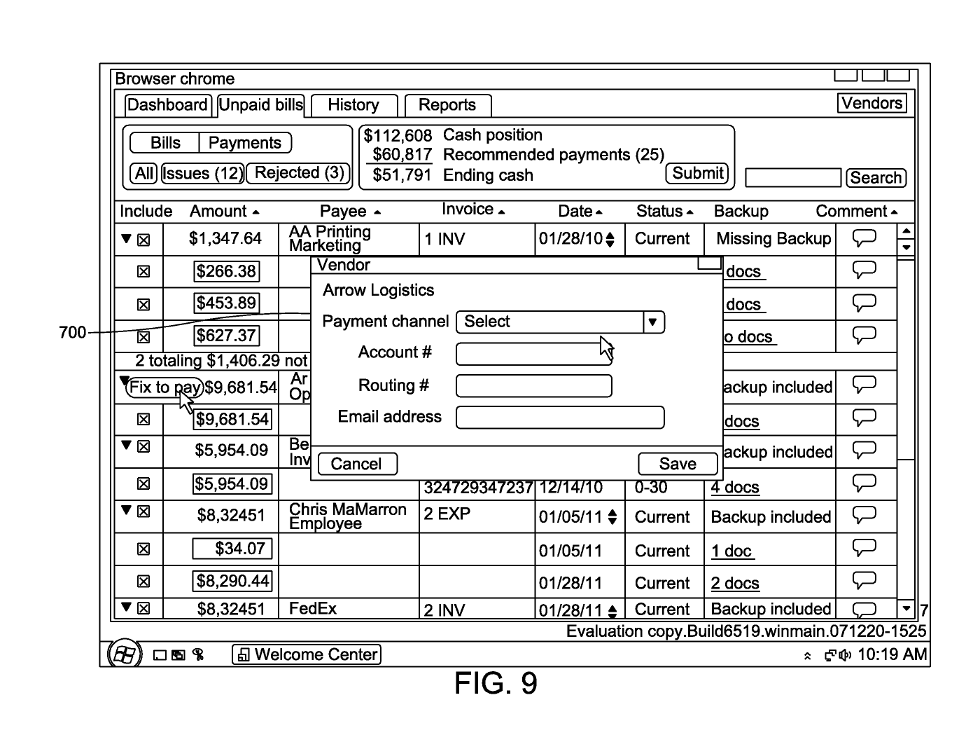

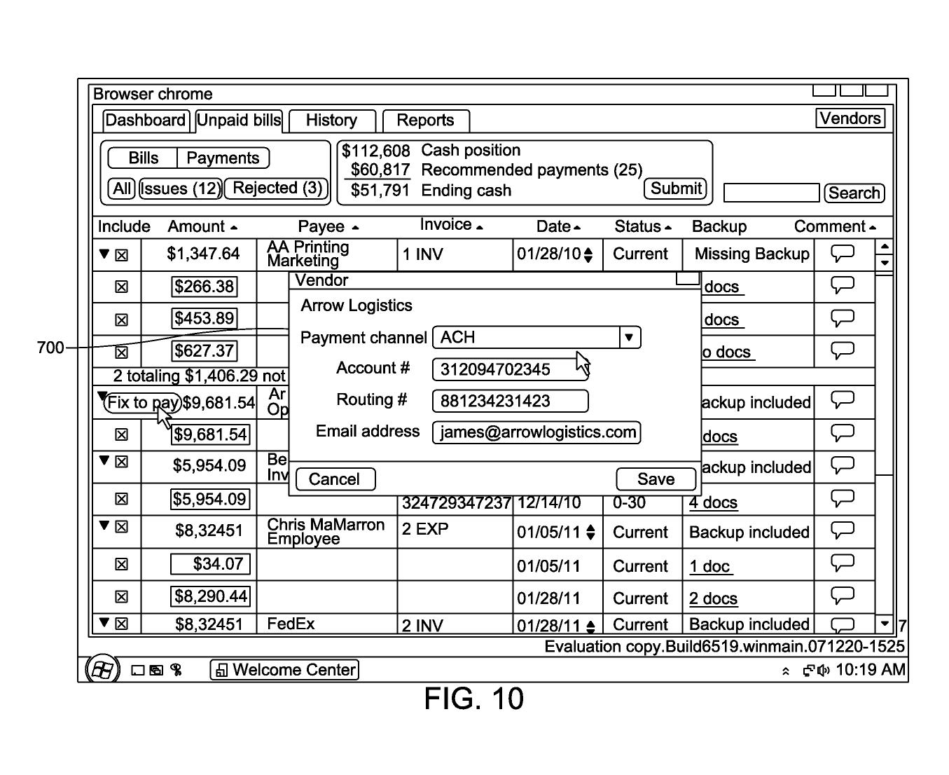

Upon receipt of the indication of a selected payment channel, the unified payment interface presents information pertinent to completing a payment request using the selected payment channel. FIG. 9 illustrates an instance in which the unified payment interface presents information pertinent to completing an ACH transaction. As shown in FIG. 9, the payment pop-up 700 includes elements through which the unified payment interface receives indications of an account number, routing number and email address. FIG. 10 illustrates the payment pop-up 700 with these elements populated with data. Upon receipt of these populated elements, the unified payment interface creates a proposed transaction for paying the indicated unpaid bill using the payment channel and associated information specified within the payment pop-up 700. In at least one example, some or all the default information provided by the unified payment interface for payment channel, payee account number, or other payee information is provided to the unified payment interface from a payment directory system, such as the payment directory system 1100.

In the example shown, the payee computer 304 provides a payee user interface through which the payee computer 304 receives and presents messages to the payee. These messages may include electronic communications such as email, text messages or chat messages. The payee computer 304 also implements a payee system interface to the payment controller computer 306 through which the payee computer 304 provides payment acceptance messages to the payment controller computer 306. In some examples, the payment acceptance messages include no sensitive information. Rather, according to these examples, the payment acceptance messages include information indicating acceptance or rejection of the proposed payment and a unique payment identifier.

According to the example of FIG. 3, the payment controller computer 306 includes an interface reciprocal to the payer system interface and an interface reciprocal to the payee system interface. The payment controller computer 306 also implements an authentication interface and a transfer interface with the payee financial institution computer 308. The authentication interface to the payee financial institution computer 308 allows the payment controller computer 306 to authenticate the payee account information included in the proposed payment with payee account information stored within the payee financial institution computer 308. The transfer interface to the payee financial institution computer 308 enables the payment controller computer 306 to transmit a digital check that transfers funds between the accounts of the payer and the payee. In addition, the payment controller computer 306 implements a positive pay list interface with the payer financial institution computer 310 through which the payment controller computer 306 provides a list of checks that the payer financial institution is authorized to pay.

Using these components, the secure payment system 300 securely transfers funds by the following process. The payer computer 302 receives a request to create a proposed payment via the payer user interface. This proposed payment includes information specifying a transfer of funds from the payer to the payee. In response to the receipt of this information, the payer computer 302 provides the payment controller computer 306 with the proposed payment and authentication credentials via the payer system interface over a secure connection.

Upon receipt of the authentication credentials and the proposed payment via the interface reciprocal to the payer system interface, the payment controller computer 306 creates a digital check drawn to the payer's account and stores the digital check in a secure data store. In some examples, some or all of the account information included in the digital check is specified in the proposed payment. In other examples, the proposed payment does not include an account number of the payer or the payee. Rather, in this example, the proposed payment includes identifiers of the payer and the payee that are not account numbers and that are stored within the payment controller 306. In this instance, payment controller 306 de-references the identifiers of the payer and the payee to determine the account numbers to be used in the digital check. In at least one example, the act of de-referencing the identifiers of the payee is accomplished with reference to payee information received from a payment directory system, such as the payment directory system described above with reference to FIGS. 11-16. For instance, in this example, the payment controller 306 uses a public identifier of payee to request the account number of the payee from the payment directory system. In response to this request, the payment directory system supplies the account number of the payee. After successful creation and storage of the digital check, the payment controller computer 306 sends an acknowledgment to the payer computer 302 via the reciprocal interface over the secure connection. The acknowledgement includes a link to the digital check stored in the secure data store.

In one example, after receiving the acknowledgment via the payer system interface, the payer computer 302 creates and transmits a digital check notification to the payee computer 304 via a message. In another example, the payment controller computer 306 creates and transmits the digital check notification to the payee computer 304 via the message. The digital check notification includes an encrypted link to the digital check stored in the secure data store administered by the payment controller computer 306. Upon receipt of the digital check notification via the message, the payee computer 304 displays the message to the payee via the payee user interface.

Under some circumstances, the payee may wish to print a copy of the digital check and process the copy manually. To support this preference, the payee user interface includes elements through which the payee computer 304 receives an indication to print a copy of the digital check. In response to receiving such an indication via the payee user interface, the payee computer 304 prints a copy of the digital check and initiates a notification indicating that the copy was printed. This notification may be transmitted to the payer computer 302 via a message. The message may be generated by the payee computer 304 or may be generated by the payment controller 306 after the payment controller has received a print notification via the payee system interface. The payer computer 302, in turn, presents an indication that a copy of the digital check was printed via the payer user interface. The printed copy of the digital check may be processed and presented for payment using the same processes as a conventional check. In addition, upon receipt of the indication to print a copy of the digital check, the payee computer 304 provides a notification indicating that a copy of the digital check was printed to the payment controller computer 306 via the payee system interface. In response to this notification, the payment controller computer 306 adds information identifying the copy of the digital check to the positive pay list and transmits the positive pay list to the payer financial institution 310 via the positive pay list interface over a secure connection.

Upon receipt of an acceptance from the payee via the payee user interface, the payee computer 304 provides a payment acceptance to the payment controller computer 306 via the payee system interface. Because the payment acceptance contains no sensitive information, the payment acceptance may be transmitted over a secure or unsecure connection. Upon receipt of the payment acceptance, the payment controller computer 306 transmits the payee account information, such as bank account and routing numbers, included in the accepted payment to the payee financial institution computer 308 via the authentication interface over a secure link.

Upon receipt of the payee account information via an interface reciprocal to the authentication interface, the payee financial institution computer 308 verifies whether the payee account information is valid and returns an account verification result to the payment controller computer 306 via the interface reciprocal to the authentication interface. Upon receive of an account verification result that indicates that the payee account information included in the accepted payment is valid, the payment controller computer 306 transmits the digital check to the payee financial institution computer 308 via the transfer interface over secure connection. In at least one example, the digital check is transmitted in standard check 21 format. In addition, upon receipt of the account verification result indicating that the payee account information included in the accepted payment is valid, the payment controller computer 306 adds information identifying the digital check to the positive pay list and transmits the positive pay list to the payer financial institution 310 via the positive pay list interface over a secure connection. Upon receipt of the digital check, the payee financial institution processes the check via conventional check processes to transfer funds from the payer account to the payee account. In some examples, when presented with a request for payment based on the digital check, the payer financial institution verifies that the digital check is identified in the positive pay list prior to transferring funds from the payer's account.

Systems and process such as those illustrated in FIG. 3 provide a host of benefits over conventional check handling procedures. For example, the costs associated with processing paper checks are avoided by use of digital checks. In addition, the risk of theft associated with physical checks is eliminated. Further, unlike conventional payment processes, the payee is not required to hold an account with the payment controller because the payment acceptance requires no authentication credentials. Rather, payee credentialing is performed using information extant in the digital check.

### ACH Payment System

FIG. 4 illustrates another computer system, a secure payment system 400, that securely conducts payments using ACH. As shown, the secure payment system 400 includes a payer computer system 402, a payment controller computer system 404, a financial institution computer system 406 and a payee computer 408. In this example, each of these computer systems are coupled to one another, and exchange information with one another, via a network, such as network 208 discussed above. In addition, according to this example, the payer computer system 402 includes a transaction proposal device in accord with the transaction proposal device 202 discussed above with reference to FIG. 2.

Each of the computer systems illustrated in FIG. 4 include interface components that enable the computer systems to exchange information with external entities, such as users or other computer systems. For instance, the payer computer 402 provides a payer user interface through which the payer computer 402 receives authentication credentials and proposed payments from the payer. The payer computer 402 also implements a payer system interface to the payment controller computer 404 through which the payer computer 402 provides authentication credentials and proposed payments to, and receives acknowledgements from, the payment controller computer 404. The payment controller computer 404 includes an interface reciprocal to the payer system interface and implements a transfer interface with the financial institution computer 406. The transfer interface to the financial institution computer 406 enables the payment controller computer 404 to transmit a payment instruction to transfer funds between the accounts of the payer and the payee. The payee computer 408 provides a payee user interface through which the payee computer 408 receives authentication credentials from the payee. The payee computer 408 also implements a payee system interface to the payment controller computer 404 through which the payee computer 408 provides authentication credentials to and receives acknowledgements from the payment controller computer 404.

Using these components, the secure payment system 400 securely transfers funds by the following process. The payer computer 402 receives a request to create a proposed payment via the payer user interface. This proposed payment includes information specifying a transfer of funds from the payer's accounts to the payee's accounts. In response to the receipt of this information, the payer computer 402 provides the payment controller computer 404 with the proposed payment and authentication credentials via the payer system interface over a secure connection. The authentication credentials include the current geographic location of the payer computer 402, the unique device identifier of the payer computer 402 and a current digital image of the user of the payer computer 402 capture by a digital camera or other imaging device.

Upon receipt of the authentication credentials and the proposed payment via the interface reciprocal to the payer system interface, the payment controller computer 404 attempts to validate the authentication credentials. This attempted validation includes determining whether the current digital image of the user, the current geographic location and the unique device identifier supplied in the authentication credentials matches a previously configured and stored digital image, geographic location and unique device identifier. The attempted validation of the digital image may be conducted by the payment controller computer 404 using automated face recognition technology or may be conducted by a human reviewing the authentication credentials. If the current digital image of the user, the current geographic location and unique device identifier match the previously stored digital image, geographic location and unique device identifier (and any other authentication credentials are found to be valid), the proposed payment is deemed authentic. Otherwise, the proposed payment is rejected. In either case, the payment controller computer 404 returns a result of the attempted validation to the payer computer 402 via the interface reciprocal to the payer system interface over the secure connection.

Continuing this example, if the payment controller computer 404 determines that the proposed payment, which in this example is an ACH payment, is authentic, the payment controller computer creates an ACH payment instruction and issues the instruction to the financial institution computer 406 via the transfer interface. Upon receipt of the ACH payment instruction, the financial institution computer 406 originates an ACH payment according to conventional ACH payment processes to transfer funds from the payer's account to the payee's account.

In some examples, the payment controller computer 404 generates remittance advice that is associated with the ACH payment. This remittance advice may include information, such as an invoice number, that identifies the financial obligation targeted for the ACH payment. In these examples, the payment controller computer 404 transmits the remittance advice to the payee computer system 408 via the payee system interface. The remittance advice may be transmitted as a message and may be organized in a variety of data formats. In one example, the remittance advice is transmitted via email and is stored in a csv file that is attached to the email. It is to be appreciated that while this example focuses on an ACH implementation, other examples may transmit remittance advice associated with payments made via other channels. Examples are not limited to a particular payment channel, transmission method or data organization scheme.

Systems and processes such as those illustrated in FIG. 4 provide for increased security by requiring payment instructions be issued by a known person from a payment device identified by a predetermined unique device identifier and located at a predetermined geographic location. Moreover, the security provided by these systems and processes is further enhanced by requiring that the payment device by locked down to prevent introduction of unauthorized components into the payment device. By operating the payment device within a closed and controlled component distribution framework, the risk of unauthorized acquisition of sensitive information by rogue components is drastically reduced.

While FIGS. 3 and 4 illustrate separate exemplary systems and methods for securely conducting digital check and ACH payments, other examples may combine components and acts of each. For instance, according to at least one example, a digital check payment is proposed using a transaction proposal device. In this example, the additional authentication credentials generated by the transaction proposal device (e.g. the digital image, the current geographic location and unique device identifier of the transaction proposal device) are used by the payment controller computer to validate the authenticity of the payer computer and the proposed payment prior to creating the digital check. Thus examples are not limited to the particular components and acts discussed with reference to either FIG. 3 or FIG. 4 in isolation.

Having thus described several aspects of at least one example, it is to be appreciated that various alterations, modifications, and improvements will readily occur to those skilled in the art. For instance, while some examples discussed in the specification are directed toward transfer of cash, examples disclosed herein may also be used in other contexts such to transfer other liquid assets, such as stocks or bonds. Such alterations, modifications, and improvements are intended to be part of this disclosure, and are intended to be within the scope of the examples discussed herein. Accordingly, the foregoing description and drawings are by way of example only.

What is claimed is:

1. A payment directory system comprising:
a payment directory executed by at least one computer system including memory, at least one network interface, and at least one processor coupled to the memory and the at least one network interface, the payment directory being configured to:
receive information descriptive of a first payment subdirectory administered by a financial institution, the information including associations between a subdirectory identifier of the first payment subdirectory and a plurality of identifiers of payees, the plurality of identifiers of payees being representative of a plurality of holders of accounts with the financial institution;
store the information; and
transmit, to a second payment subdirectory different from the first payment subdirectory via the at least one network interface, data descriptive of at least a portion of the information, the data including at least one association between the subdirectory identifier and an identifier from the plurality of identifiers of payees.

2. The payment directory system according to claim 1, wherein the payment directory is further configured to:
provide an interface configured to receive the information descriptive of the first payment subdirectory; and
receive the information descriptive of the first payment subdirectory via the interface.

3. The payment directory system according to claim 2, wherein the interface includes at least one of a user interface and a subdirectory interface.

4. The payment directory system according to claim 3, wherein the subdirectory interface is configured to receive the information descriptive of the first payment subdirectory from at least one of the first payment subdirectory and a third payment subdirectory.

5. The payment directory system according to claim 4, wherein the plurality of identifiers of payees include public identifiers.

6. The payment directory system according to claim 5, further comprising a plurality of payment subdirectories including the first, second, and third payment subdirectories, each payment subdirectory of the plurality of payment subdirectories being executed by one or more computer systems and being configured to:
receive payee information descriptive of a payee, the payee information including a private identifier of the payee and a public identifier of the payee;
store the payee information; and
transmit data descriptive of an association between the payment subdirectory and the public identifier.

7. The payment directory system according to claim 6, wherein each payment subdirectory of the plurality of payment subdirectories is further configured to:
receive a request for information descriptive of a payee; and
transmit, responsive to the request, payee information regarding the payee.

8. A method for providing a payment directory using at least one computer system including memory and at least one processor coupled to the memory, the method comprising:
receiving, by the at least one computer system, information describing a first payment subdirectory administered by a financial institution, the information associating a subdirectory with a plurality of payees, the plurality of payees including a plurality of holders of accounts with the financial institution;
storing the information; and
transmitting data descriptive of at least a portion of the information to a second payment subdirectory different from the first payment subdirectory, the data associating the subdirectory with at least one payee of the plurality of payees.

9. The method according to claim 8, further comprising receiving the information describing the first payment subdirectory via an interface.

10. The method according to claim 9, wherein receiving the information includes receiving the information via at least one of a user interface and a subdirectory interface.

11. The method according to claim 10, wherein receiving the information via the subdirectory interface includes receiving the information from at least one of the first payment subdirectory and a third payment subdirectory.

12. The method according to claim 11, wherein receiving the information includes receiving a plurality of public identifiers of payees.

13. The method according to claim 12, further comprising:
receiving payee information describing a payee, the payee information including a private identifier of the payee and a public identifier of the payee;
storing the payee information; and
transmitting data associating the payment subdirectory with the public identifier.

14. The method according to claim 13, further comprising:
receiving a request for information describing a payee; and
transmitting, responsive to the request, payee information describing the payee.

15. A payment subdirectory system comprising:
a memory;
at least one network interface;
at least one processor coupled to the memory and the at least one network interface; and
a payment subdirectory executed by the processor and configured to:
receive payee information descriptive of at least one payee, the payee information including a private identifier of the at least one payee and a public identifier of the at least one payee;
store the payee information; and
transmit, to a payment directory via the at least one network interface, data descriptive of an association between the payment subdirectory and the public identifier.

16. The payment subdirectory system according to claim 15, wherein the payment subdirectory is further configured to:
provide an interface configured to receive the payee information descriptive of the at least one payee; and
receive the payee information descriptive of the at least one payee via the interface.

17. The payment subdirectory system according to claim 16, wherein the interface includes at least one of a user interface, a directory interface, and a subdirectory interface.

18. The payment subdirectory system according to claim 17, wherein the subdirectory interface is configured to receive the payee information descriptive of the at least one payee from another payment subdirectory.

19. The payment subdirectory system according to claim 18, wherein payment subdirectory is further configured to:
receive a request for information descriptive of a payee; and
transmit, responsive to the request, payee information descriptive of the payee.

20. The payment subdirectory system according to claim 19, wherein the request includes an identifier of a requestor and the payment subdirectory is further configured to:
validate that the requestor is trusted; and
transmit payee information including the private identifier to the requestor.
